(19) United States
(12) Patent Application Publication
(10) Pub. No.: US 2004/0074436 A1
(43) Pub. Date: Apr. 22, 2004

(54) Magnetic bookmark

(76) Inventor: Michael Wu, Taipei (TW)

Correspondence Address: BRUCE H. TROXELL, SUITE 1404, 5205 LEESBURG PIKE, FALLS CHURCH, VA, 22041, US

(21) Appl. No.: 10/301,749

(22) Filed: Nov. 22, 2002

(30) Foreign Application Priority Data
Oct. 22, 2002 (TW) 91216899

(51) Int. Cl. B42D 9/00

(52) U.S. Cl. 116/234

(57) ABSTRACT

Magnetic bookmark including a soft sheet formed with at least one weakened foldable section dividing the soft sheet into at least two folding faces. At least one magnetically attracting section and at least one magnetically attractable section are disposed on each of the folding faces. The two folding faces are foldable toward each other about the foldable section to attract and attach to each other. Accordingly, the folded bookmark can ride on a page with the magnetically attracting section and magnetically attractable section of the folding faces attracting each other so as to clip the page.

### BACKGROUND OF THE INVENTION

The present invention is related to an improved magnetic bookmark including a soft sheet formed with at least one weakened foldable section dividing the soft sheet into at least two folding faces. Magnetically attracting sections and magnetically attractable sections are disposed on the folding faces. The two folding faces are foldable toward each other about the foldable section. The folded bookmark can ride on a page with the magnetically attracting section and magnetically attractable section attracting each other so as to clip the page.

A conventional bookmark is a paper-made or plastic-made thin sheet which can be inserted between pages of a book. Another type of bookmark (as shown in FIG. 1) is a metal-made or plastic-made laminate having a clip section 61.

The paper-made or plastic-made thin sheet has light weight and can be easily carried. However, such paper-made or plastic-made thin sheet is easy to fold and damage or tear off. Therefore, such bookmark often has some folding tracks or fissures which will affect the appearance or use of the bookmark. Moreover, such bookmark is clamped between the pages simply by the clamping force of the pages of the book. When turning the pages, the bookmark tends to drop and miss. This leads to inconvenience in use of such bookmark. With respect to the second type of bookmark, the clip section 61 can ride on the edge 91 of a page 90 to clip the same. A part of the bookmark 90 protrudes from the edge 91 for a user to easily find the marked page. However, the page 90 is generally made of paper material and quite thin so that the page 90 can be hardly frequently bear the clipping force of the clip section 61. When suffering a too great external force, the page may be damaged.

Moreover, such bookmark has a relatively heavy weight. When holding the book with a hand, the bookmark often drops or slips out due to its own weight.

The metal-made bookmark is not easy to damage or break. However, the rigid metal-made bookmark often cuts and damages the page.

FIG. 2 shows another type of paper-made of plastic-made bookmark 70 which has a form of a strip. The bookmark 70 can be folded to form two opposite folding faces 71, 72. A magnet 81 and a magnetically attractable block 82 are respectively disposed on corresponding portions of the folding faces 71, 72. After the two folding faces 71, 72 are inserted between the pages 90, the magnet 81 can attract the magnetically attractable block 82 so that the bookmark can clip the page.

However, the magnet 81 and the magnetically attractable block 82 have considerable thickness. Therefore, the bookmark 70 will lead to a thickened section of the book. As a result, it is inconvenient to close the book or place the book with other books on a shelf side by side. In addition, the book may be even deformed.

Also, the paper or plastic material is soft and easy to wear, while the magnet or magnetically attractable block are hard and not easy to wear. The hard block is generally simply fixed on the paper or plastic material by adhesion. After repeatedly folded, folding tracks or fissures are often formed near the adjoining section between the soft and hard material. Therefore, the hard magnet and magnetically attractable block often detach from the bookmark. Therefore, it is necessary to provide an improved bookmark to eliminate the above shortcomings.

### SUMMARY OF THE INVENTION

It is therefore a primary object of the present invention to provide an improved magnetic bookmark formed of a soft sheet. The soft sheet has at least one weakened foldable section dividing the soft sheet into two folding faces. At least one magnetically attracting section and at least one magnetically attractable section are disposed on each of the folding faces. The two folding faces are foldable toward each other about the foldable section to attract and attach to each other. Accordingly, the folded bookmark can ride on a page with the two folding faces respectively suspending from the edge to two faces of the page. The magnetically attracting section and the magnetically attractable section of the folding faces attract and attach to each other so that the two folding faces provide a clipping effect for the page. The entire structure of the bookmark is thin and soft so that the bookmark can be snugly clamped between the pages without protrusion. In addition, the shortcomings resulting from different materials of the conventional bookmark can be eliminated.

The present invention can be best understood through the following description and accompanying drawings wherein:

### BRIEF DESCRIPTION OF THE DRAWINGS

FIG. 1 shows a conventional bookmark;

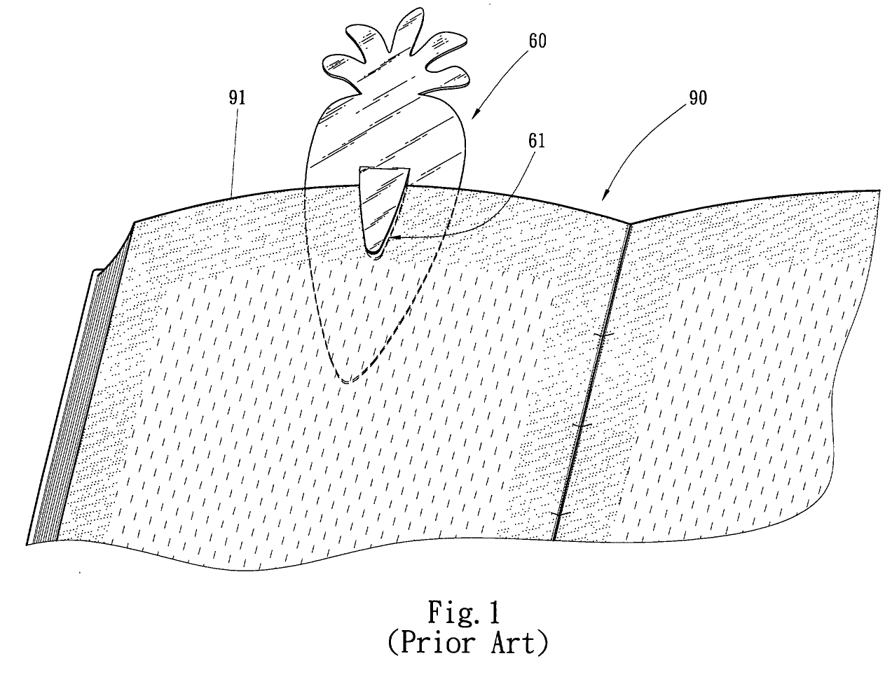

FIG. 2 shows another type of conventional bookmark;

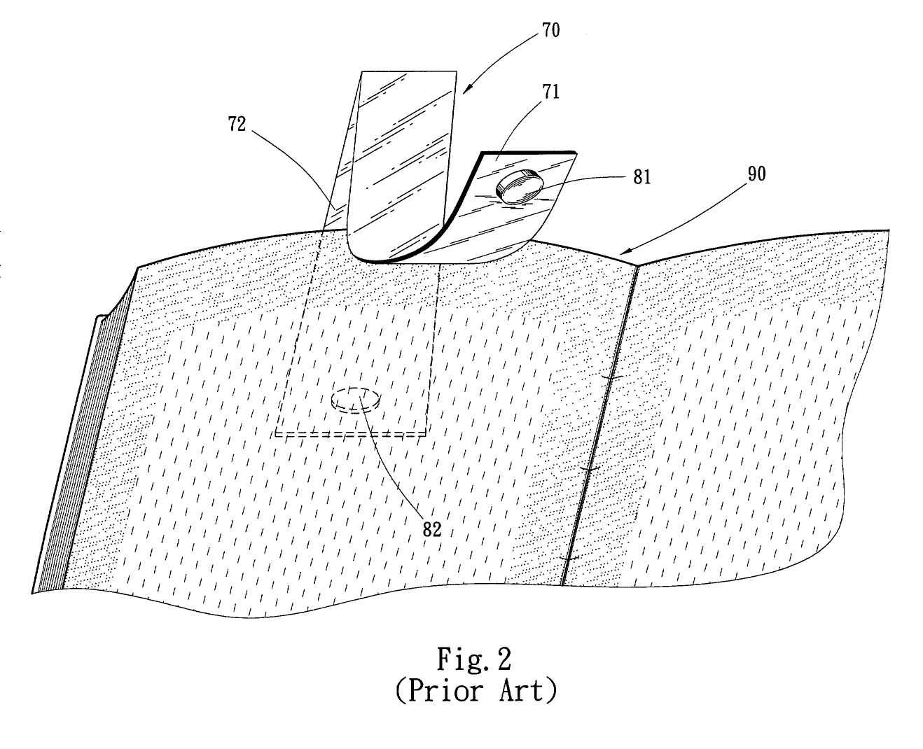

FIG. 3 is a perspective view of the bookmark of the present invention;

FIG. 4 shows an aspect of arrangement of the magnetic sections of the bookmark of the present invention;

FIG. 5 shows another aspect of arrangement of the magnetic sections of the bookmark of the present invention;

FIG. 6 shows that a decorative laminate is disposed on the other face of the bookmark of the present invention;

FIG. 7 shows that the folding faces of the bookmark of the present invention have unequal length;

FIG. 8 shows that the edge of the soft sheet of the bookmark of the present invention has irregular shape; and

FIG. 9 shows another embodiment of the weakened foldable section of the bookmark of the present invention.

### DETAILED DESCRIPTION OF THE PREFERRED EMBODIMENTS

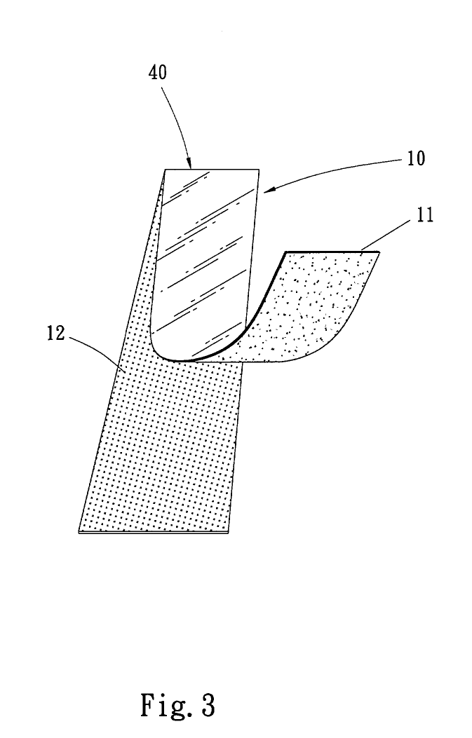

Please refer to FIGS. 3 to 5. The magnetic bookmark of the present invention includes a soft sheet 10 (such as soft magnet sheet) at least one face of which is directly provided with magnetically attracting section 20 or magnetically attractable section 30. The soft sheet 10 has at least one weakened foldable section 40 spaced from the two sections by equal distance.

In a preferred embodiment, the weakened section 40 is formed at the central portion of the soft sheet 10. In practice, the foldable section 40 is a nonmagnetic section dividing the soft sheet 10 into at least two folding faces 11, 12 which can be overlapped onto each other.

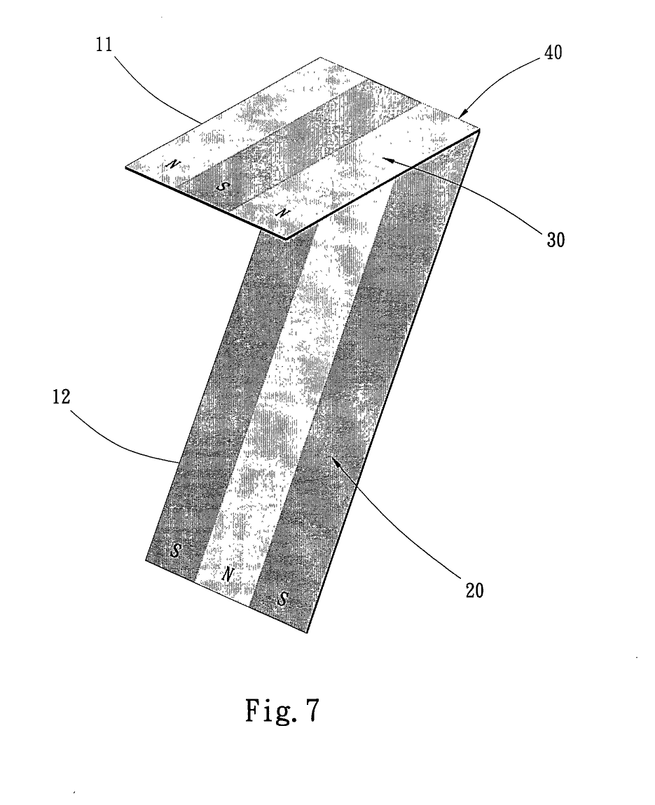

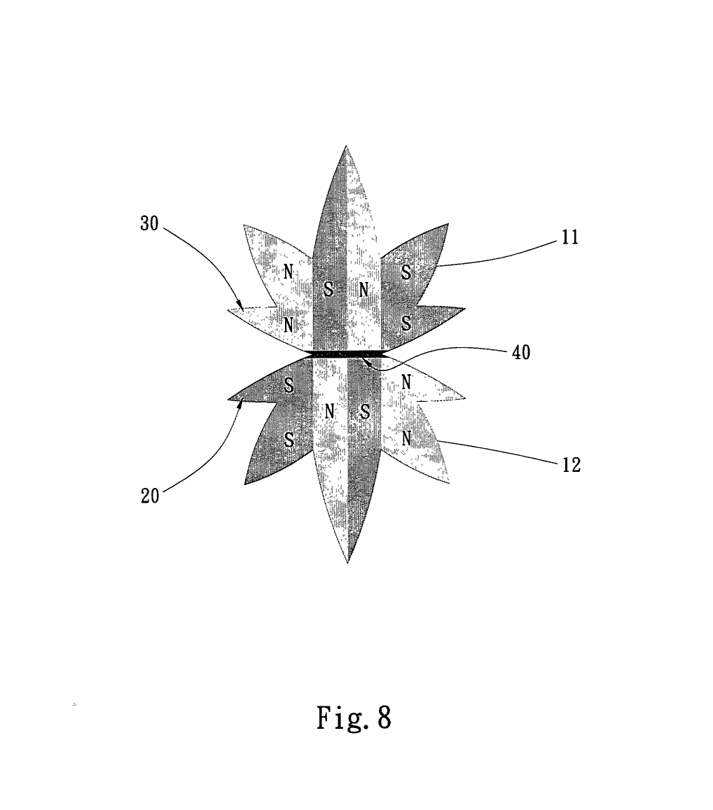

The folding faces 11, 12 can have equal or unequal lengths (respectively as shown in FIG. 3 and FIG. 7). Preferably, as shown in FIG. 8, the soft sheet 10 can be cut into a shape simulating a certain thing. Alternatively, the soft sheet 10 can have an irregular shape to achieve a beautifying effect.

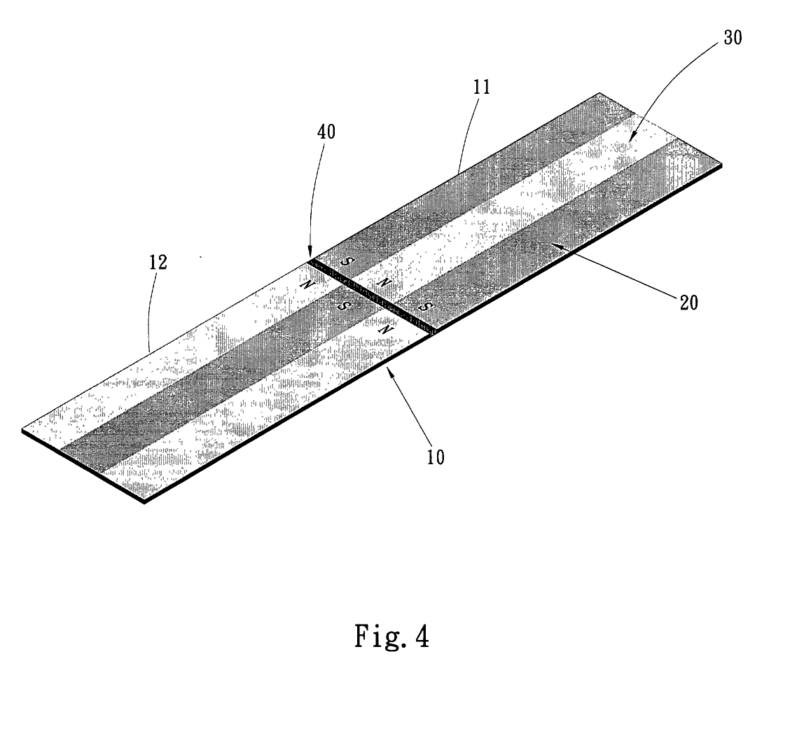

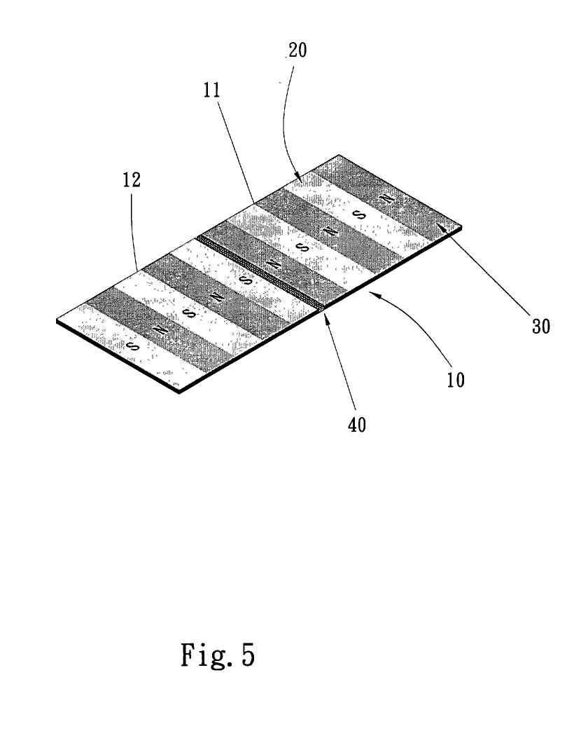

The foldable section 40 serves as the border between the folding faces 11, 12. The magnetically attracting section 20 and the magnetically attractable section 30 are longitudinally (as shown in FIG. 4) or transversely (as shown in FIG. 5) arranged over the folding faces 11, 12, whereby the magnetic polarities of each of the folding faces 11, 12 are interlaced with and adjacent to each other. Moreover, the polarity of the magnetically attractable section 30 of one folding face is different from the polarity of the corresponding magnetically attracting section 20 of the other folding face to which the magnetically attractable section 30 is attachable. Therefore, when the two folding faces 11, 12 are folded toward each other about the foldable section 40, the magnetically attracting section 20 and the magnetically attractable section 30 are attached to and overlapped onto each other. Accordingly, the folding faces 11, 12 can effectively attract each other.

In use, the foldable section 40 between the two folding faces 11, 12 directly ride on the edge of a page to be marked and the two folding faces 11, 12 respectively suspend from the edge to two faces of the page. The magnetically attracting section 20 and the magnetically attractable section 30 of the folding faces 11, 12 attract and attach to each other so that the two folding faces 11, 12 provide a clipping effect. Accordingly, the folding faces 11, 12 can firmly clip the page and the soft sheet 10 can serve as a bookmark.

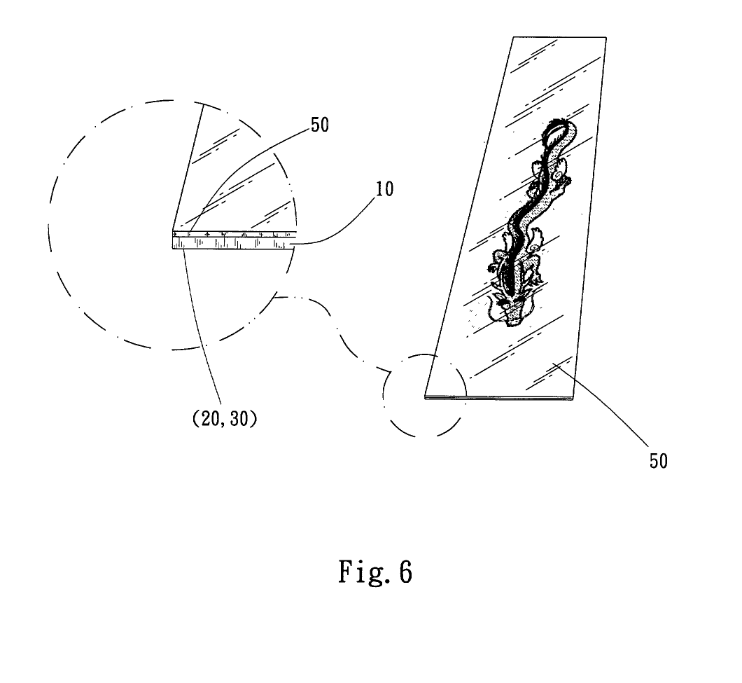

FIG. 6 shows another embodiment of the soft sheet 10 of the present invention, which has a nonmagnetic face connected with a decorative laminate 50. The laminate 50 is printed with plane or embossed or dented pictures or characters. The decorative laminate 50 can be a soft paper or plastic film which is integrally fixed on the other face of the soft sheet 10 by way of adhesion or high-frequency press or integral molding. The decorative laminate 50 can be freely flexed along with the sheet body 10. By means of the decorative laminate 50, the appearance of the bookmark is beautified.

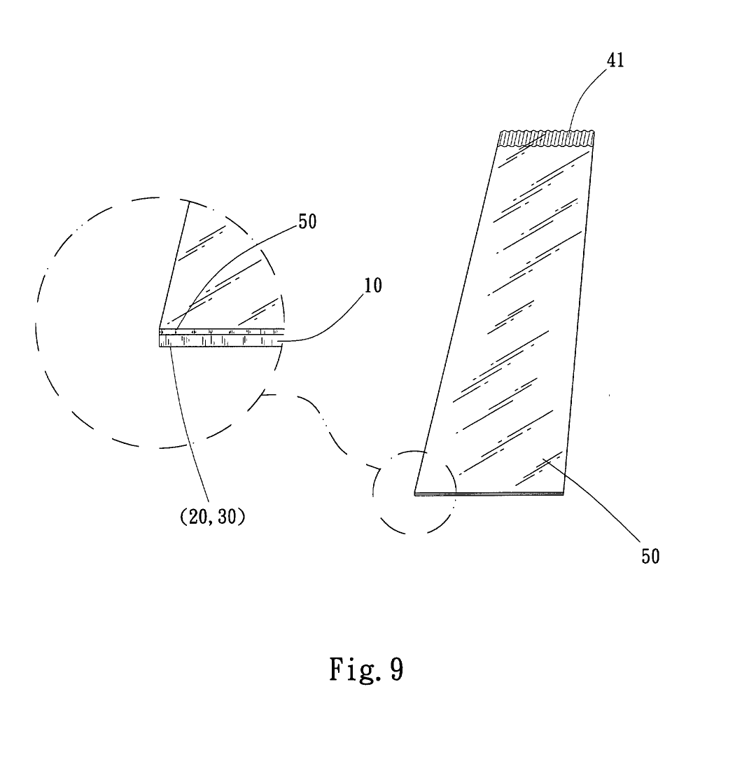

Moreover, the weakened foldable section 40 can be further processed by way of mold press or high-frequency press to form a pressed striped section 41 in the attaching direction of the folding faces 11, 12 (as shown in FIG. 9). Accordingly, the weakened foldable section 40 is thinned to facilitate the folding. The striped end is apparently different from the plane ends of the folding faces 11, 12 defining the opening of the bookmark so that a user can easily identify the open side of the bookmark.

The above embodiments are only used to illustrate the present invention, not intended to limit the scope thereof. Many modifications of the above embodiments can be made without departing from the spirit of the present invention.

What is claimed is:

1. Magnetic bookmark comprising a soft sheet formed with at least one weakened foldable section dividing the soft sheet into at least two folding faces, at least one magnetically attracting section and at least one magnetically attractable section being disposed on each of the folding faces, the two folding faces being foldable toward each other about the foldable section to attract and attach to each other, whereby the folded bookmark can ride on a page with the magnetically attracting section and magnetically attractable section of the folding faces attracting each other so as to clip the page.

2. Magnetic bookmark as claimed in claim 1, wherein the weakened foldable section is a nonmagnetic section.

3. Magnetic bookmark as claimed in claim 1, wherein the soft sheet has a shape simulating a certain thing.

4. Magnetic bookmark as claimed in claim 1, wherein the weakened foldable section is formed with a pressed striped section.

5. Magnetic bookmark as claimed in claim 1, wherein the magnetic polarities of each of the folding faces are interlaced with and adjacent to each other and the polarity of the magnetically attractable section of one folding face is different from the polarity of the magnetically attracting section of the other folding face to which the magnetically attractable section is attachable.

6. Magnetic bookmark as claimed in claim 1, wherein the magnetically attracting section and the magnetically attractable section are longitudinally or transversely arranged over the folding faces, whereby the magnetic polarities of each of the folding faces are interlaced with and adjacent to each other.

7. Magnetic bookmark as claimed in claim 3, wherein the magnetically attracting section and the magnetically attractable section are longitudinally or transversely arranged over the folding faces, whereby the magnetic polarities of each of the folding faces are interlaced with and adjacent to each other.

8. Magnetic bookmark as claimed in claim 5, wherein the magnetically attracting section and the magnetically attractable section are longitudinally or transversely arranged over the folding faces, whereby the magnetic polarities of each of the folding faces are interlaced with and adjacent to each other.

9. Magnetic bookmark as claimed in claim 1, wherein the folding faces have equal or unequal lengths.

10. Magnetic bookmark as claimed in claim 3, wherein the folding faces have equal or unequal lengths.

11. Magnetic bookmark as claimed in claim 5, wherein the folding faces have equal or unequal lengths.

12. Magnetic bookmark as claimed in claim 1, wherein a decorative laminate is connected with a nonmagnetic face of the soft sheet.

13. Magnetic bookmark as claimed in claim 3, wherein a decorative laminate is connected with a nonmagnetic face of the soft sheet.

14. Magnetic bookmark as claimed in claim 12, wherein the decorative laminate is a paper or plastic film.

15. Magnetic bookmark as claimed in claim 13, wherein the decorative laminate is a paper or plastic film.

16. Magnetic bookmark as claimed in claim 12, wherein a surface of the decorative laminate is formed with embossed solid pictures or characters.

17. Magnetic bookmark as claimed in claim 13, wherein a surface of the decorative laminate is formed with embossed solid pictures or characters.

18. Magnetic bookmark as claimed in claim 14, wherein a surface of the decorative laminate is formed with embossed solid pictures or characters.

19. Magnetic bookmark as claimed in claim 15, wherein a surface of the decorative laminate is formed with embossed solid pictures or characters.

20. Magnetic bookmark as claimed in claim 12, wherein a surface of the decorative laminate is formed with plane pictures or characters.

21. Magnetic bookmark as claimed in claim 13, wherein a surface of the decorative laminate is formed with plane pictures or characters.

22. Magnetic bookmark as claimed in claim 14, wherein a surface of the decorative laminate is formed with plane pictures or characters.

23. Magnetic bookmark as claimed in claim 15, wherein a surface of the decorative laminate is formed with plane pictures or characters.

24. Magnetic bookmark as claimed in claim 12, wherein a surface of the decorative laminate is formed with dented pictures or characters.

25. Magnetic bookmark as claimed in claim 13, wherein a surface of the decorative laminate is formed with dented pictures or characters.

26. Magnetic bookmark as claimed in claim 14, wherein a surface of the decorative laminate is formed with dented pictures or characters.

27. Magnetic bookmark as claimed in claim 15, wherein a surface of the decorative laminate is formed with dented pictures or characters.

28. Magnetic bookmark as claimed in claim 1, wherein the soft sheet is a soft magnet.

29. Magnetic bookmark as claimed in claim 3, wherein the soft sheet is a soft magnet.

30. Magnetic bookmark as claimed in claim 5, wherein the soft sheet is a soft magnet.

31. Magnetic bookmark as claimed in claim 6, wherein the soft sheet is a soft magnet.

32. Magnetic bookmark as claimed in claim 7, wherein the soft sheet is a soft magnet.

33. Magnetic bookmark as claimed in claim 8, wherein the soft sheet is a soft magnet.

34. Magnetic bookmark as claimed in claim 9, wherein the soft sheet is a soft magnet.

35. Magnetic bookmark as claimed in claim 10, wherein the soft sheet is a soft magnet.

36. Magnetic bookmark as claimed in claim 11, wherein the soft sheet is a soft magnet.

37. Magnetic bookmark as claimed in claim 12, wherein the soft sheet is a soft magnet.

38. Magnetic bookmark as claimed in claim 13, wherein the soft sheet is a soft magnet.

39. Magnetic bookmark as claimed in claim 14, wherein the soft sheet is a soft magnet.

40. Magnetic bookmark as claimed in claim 15, wherein the soft sheet is a soft magnet.
